(19) United States
(12) Patent Application Publication
(10) Pub. No.: US 2008/0144014 A1
(43) Pub. Date: Jun. 19, 2008

(54) Apparatus for wafer inspection

(75) Inventors: Wolfgang Vollrath, Burbach (DE); Alexander Buettner, Wetzlar (DE); Christof Krampe-Zadler, Castrop-Rauxel (DE)

Correspondence Address: Davidson, Davidson & Kappel, LLC, 485 7th Avenue, 14th Floor, New York, NY, 10018, US

(73) Assignee: Vistec Semiconductor Systems GmbH, Weilburg (DE)

(21) Appl. No.: 11/999,640

(22) Filed: Dec. 6, 2007

(30) Foreign Application Priority Data
Dec. 15, 2006 (DE) 102006059190.9-52

(51) Int. Cl. G01N 21/00

(52) U.S. Cl. 356/73

(57) ABSTRACT

An apparatus for inspecting a wafer, comprising a first illuminator for radiating an illumination beam in a first illumination beam path onto a surface of the wafer and being configured as continuous light source; a second illuminator for radiating an illumination light beam in a second illumination beam path onto a surface of the wafer and being configured as continuous light source; a first detector means defining a first detection beam path; a second detector means defining a second detection beam path, wherein the first and the second detector means have a predetermined spectral sensitivity and detect data of at least an illuminated area moveable in a scanning direction on the surface of the wafer in a plurality of different spectral ranges.

This claims the benefit of German Patent Application No. DE 10 2006 059 190.9, filed on Dec. 15, 2006 and hereby incorporated by reference herein.

The present invention relates to an apparatus for inspecting a wafer, including a first illumination device for radiating an illumination light beam in an illuminating beam path onto a surface of the wafer, and a second illumination device for radiating an illumination light beam in a second illumination beam path onto the surface of the wafer. A first detector is also provided, which defines the first detection beam path. In addition, a second detector is provided, which defines a second detection beam path. The two detectors have a predetermined spectral sensitivity, and the data from an illuminated area on the surface of the wafer is detected in a plurality of different spectral ranges.

### BACKGROUND

To improve quality and efficiency in the manufacture of integrated circuits, apparatus for detecting macro defects on the surface of wafers are used, so that wafers found to be defective can be rejected or post-processed until the quality of a currently inspected wafer is sufficient.

Optical inspection apparatus are known, which radiate an illumination light beam by means of an illumination device onto a surface of the wafer. An image recording means is also provided to detect an image or data from the illuminated area on the surface of the wafer in a plurality of spectral ranges, i.e. spectrally resolved. Herein, there can be problems with the further processing of the color signals detected by the image detector if the color image channels of the image detector are driven in an irregular fashion, which can result in relatively low signal to noise ratio or to overdriving in the individual color signals.

German patent application publication DE 101 32 360 discloses an apparatus for the color neutral brightness adjustment in the illumination beam path of a microscope. The invention is based on the idea that with microscopes operated with an incandescent lamp similar to a black light, the color temperature of the color spectrum emitted by the incandescent lamp is shifted from the blue spectral range to the red spectral range when the input lamp power is reduced. To compensate the red shift a variable optical filter is provided in the illumination beam path having a variable transmission for red light across the filter area. By displacing the filter in the illumination beam path, a blue shift is caused, which is compensated by the red shift caused by the reduction of the electric power.

German patent application publication DE 100 31 303 discloses an illumination apparatus having LEDs. Due to the degradation of the LED material, the intensity and wave length of the light emitted by the LED changes over time. In order to achieve uniform illuminating characteristics, a feedback control is provided so that a predetermined color temperature and intensity of the LEDs can be maintained.

U.S. Pat. No. 6,847,443 B1 discloses a system and a method for detecting surface defects by means of light that has a plurality of wavelengths with narrow band widths. The defects primarily occur in surface structures formed on the surface of a semiconductor wafer. A light source, preferably a flash lamp light source, is provided, which supplies the illumination light. The illumination light is divided into a plurality of selected bands having respective bandwidths by means of a filter. The light is then transferred to a diffuser by means of an optical fiber, and from there the light is directed onto the surface of a semiconductor wafer. A camera receives a plurality of images, wherein each image has been produced from a different section of the spectrum. The images can be generated both by reflected and diffracted light. The images can be stored or compared with the image of a calibration wafer. The small bandwidth of the illumination light is chosen such that the wavelength of the illumination light is in the range of maximum sensitivity of each camera channel. By comparing the measured light intensities with the light intensities measured on a defect free wafer, the contrast values can be determined for each area of the wafer surface. It has been shown that the larger the defect, the greater the contrast value. The narrow band illumination and the associated narrow band detection result in the contrast being substantially improved. However, this principle is not sufficient to further improve the detection speed and the detection sensitivity.

### SUMMARY OF THE INVENTION

An object of the present invention is to provide an apparatus, with which the detection speed and the detection sensitivity can be further improved.

The present invention also provides an apparatus having a first illumination device for radiating an illumination beam in a first illumination beam path onto a surface of the wafer and being configured as continuous light source. A second illumination device is provided for radiating an illumination light beam in a second illumination beam path onto a surface of the wafer and being configured as continuous light source. A first detector defines a first detection beam path. A second detector defines a second detection beam path, wherein the first and the second detector have a predetermined spectral sensitivity and detect data of at least an illuminated area moveable in a scanning direction on the surface of the wafer. The detection is done in a plurality of different spectral ranges.

According to another embodiment of the present invention, the above object is also achieved by an apparatus including only two illumination devices, each configured as a continuous light source. In addition, a polarizer may be provided in the illumination beam path of at least one of the illumination beam paths of the two illumination devices.

The illumination device can include a light source which emits light having a plurality of discretely formed intensity peaks at different wavelengths. Moreover, the illumination device may include a continuously adjustable light source so that each required wavelength range can be set. It goes without saying that the spectral width of the wavelength range required can be adapted to the requirements needed for the inspection.

The illumination device can further include an LED illumination. The illumination device can also be provided as a broad band light source, wherein the individual wavelengths or wavelength ranges, are adjustable by means of corresponding filters.

The detector can be configured as a line camera. It is also conceivable that the detector includes a trilinear detector, wherein the individual lines of the trilinear detector are each provided with a suitable wavelength filter. Moreover, the detector can include three light-sensitive chips arranged around a prism arrangement in such a way, that each of the chips receives a different wavelength. The detector may also include a two-dimensional light-sensitive chip having a dispersive element upstream of it which directs the different wavelength ranges onto different areas of the light-sensitive chip. This detector can be regarded as an imaging spectrometer.

According to an embodiment of the present invention, a beam splitter is provided for making the light of the illumination device collinear with the detection beam path of the detector. The beam splitter used here can include polarizing characteristics.

In another embodiment of the present invention, a first and a second illumination device, and a first and a second detector are provided. The illumination devices each include a continuous light source, and in the illumination beam path of at least one of the illumination devices, a polarizer may be provided in a further embodiment.

The two illumination devices are arranged such that the light from the first illumination device and the second illumination device coincide in the same area on the surface of the wafer. The illumination beam path of the first illumination device is made co-linear with the detection beam path of the first detector via a beam splitter.

The second illumination device and the second detector are arranged at an angle to the normal on the surface of the wafer. Herein, the angle at which the second detection beam path is inclined, is adjustable.

The first detector can be configured to be monochromatic, for example, so that the detection has high resolution. The second detector can be polychromatic, for example, and has a lower resolution than the first detector.

It is advantageous if a polarizer is arranged in at least one of the illumination beam paths. In addition, with grating-type structures (so-called zero order gratings) the orientation of the grating relative to the polarization direction can be determined. It is also possible to determine in this way whether or not (and if necessary where) there are grating structures on the wafer. This cannot be achieved with the usual rather low resolution in the range of >5 μm in current macro inspection. If the grating period of the structures present on the wafer is in the area of a few illumination wavelengths and less, use of the present invention is particularly advantageous.

### BRIEF DESCRIPTION OF THE DRAWINGS

FIG. 1 is a schematic view of a system for detecting defects on wafers, or structured semiconductor substrates;

FIG. 2a is a schematic representation of an embodiment of the present invention, wherein a first and second illumination device, and a first and a second detector are provided;

FIG. 2b shows a possible arrangement of the illumination fields on the surface of the wafer;

FIG. 3 is a schematic representation of a further embodiment of the present invention, wherein the illumination device and the detector are arranged at an angle to each other;

FIG. 4 is a schematic representation showing how the whole surface area of a wafer, or a structured semiconductor component, is detected with the apparatus according to the present invention;

FIG. 5a shows a detailed view of the arrangement shown in FIG. 5a, wherein the detector includes a trilinear detector;

FIG. 5b shows another embodiment of the detector, wherein the detector includes a plurality of detector chips;

FIG. 5c shows an embodiment of the detector, wherein the detector includes a two dimensional detector chip;

FIG. 6a is a schematic representation of an embodiment of the arrangement of the illumination device and the detector, wherein a DMD is arranged in the illumination beam path;

FIG. 6b is a schematic representation of a possible illumination pattern created by means of the DMD on the surface of the wafer;

FIG. 7 is a representation of the light emitted by a line light source;

FIG. 8 is a representation of the intensity characteristic of a continuously adjustable light source;

FIG. 9 is a representation of the intensity characteristic of the light emitted by an LED;

FIG. 10 is a schematic representation of the acquisition of corresponding spectral illumination bands, wherein the light source used is a broad band light source.

### DETAILED DESCRIPTION

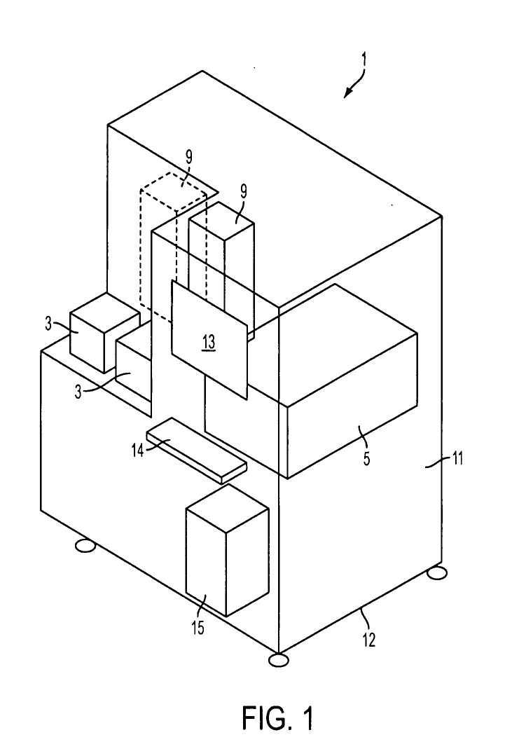

FIG. 1 shows a system for inspecting structures on semiconductor substrates. System 1 includes the present invention in its interior. System 1 consists, for example, of at least one cartridge element 3 for the semiconductor substrates or wafers. Images, image data or data of the individual wafers or structured semiconductor substrates are recorded in a measuring unit 5. A transfer mechanism 9 is provided between cartridge element 3 for the semiconductor substrates or wafers and measuring unit 5. The system itself is enclosed in a housing 11, wherein housing 11 defines a base area 12. Further, at least one computer is integrated in system 1, which is for evaluating or processing the individual image data. System 1 is provided with a display 13 and a keyboard 14. The user can make data inputs for controlling the system or even parameter inputs for evaluating the recorded data, image data or images from the individual wafers, using keyboard 14. A plurality of user interfaces is shown to the user of system 1 on display 13. In addition, information on the current measurement is shown to the user on the user interface. System 1 can further have a modular structure so that further measuring means (not shown) can be added to system 1. The further measuring means are then usable for different inspection methods.

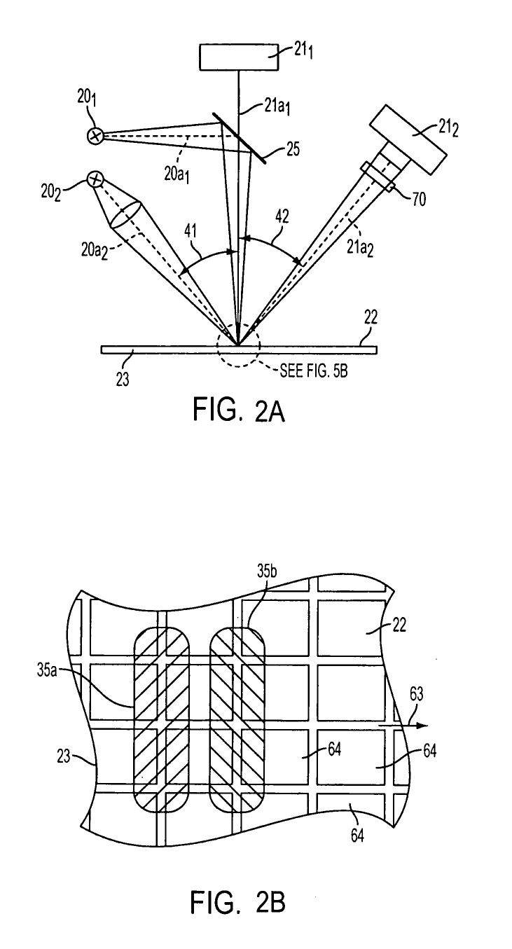

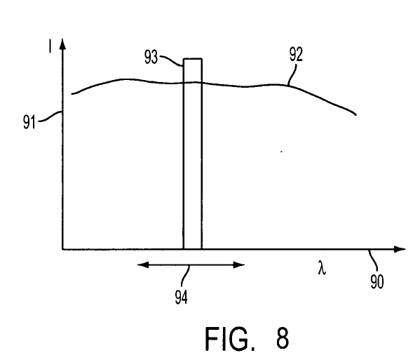

FIG. 2a shows a further embodiment of the apparatus according to the present invention. Here, a first illumination device 20₁ is provided defining a first illumination beam path 20a₁. Further, a second illumination device 20₂ is provided defining a second illumination beam path 20a₂. The first illumination device 20₁ has a first detector 21₁ associated with it. Second illumination device 20₂ has a second detector 21₂ associated with it. In first illumination beam path 20a₁ of first illumination device 20₁, a beam splitter 25 is also provided for making first illumination beam path 20a₁ collinear with first detection beam path 21a₁. Preferably beam splitter 25 is configured as a polarizing beam splitter. Second illumination beam path 20a₂ of second illumination device 20₂ and second detector 21₂ are arranged in such a way that second illumination beam path 20a₂ and second detection beam path 21a₂ are inclined with respect to normal 30 on surface 22 of wafer 23 by a first angle 41 and a second angle 42. First detector 21₁ and second detector 21₂ can be configured to be monochromatic or polychromatic. For the case in which detectors 21₁ or 21₂ are monochromatic, a high resolution detection of surface 22 of wafer 23 is possible. For the case in which detectors 21₁ or 21₂ are polychromatic, a low resolution detection of surface 22 of wafer 23 is possible. First angle 41, which defines the inclination of second illumination beam path 20a₂ with respect to normal 30, is equal to second angle 42 at which second detection beam path 21a₂ is inclined with respect to normal 30, identifying it as a bright-field arrangement. A dark-field arrangement is also conceivable, wherein first angle 41 and second angle 42 are not equal. There is a plurality of embodiments for configuring detectors 21₁ or 21₂. In second detection beam path 21a₂, a dispersive element is further arranged for directing light reflected from surface 22 of wafer 23 onto respective detector elements of the polychromatic detector. FIGS. 8a, 8b and 8c show three different embodiments for the possible configuration of detectors 21₁ and 21₂.

FIG. 2b shows a possible arrangement of illumination fields 35a and 35b on surface 22 of wafer 23. Apart from the possibility that illumination fields 35a and 35b of first illumination device 20₁ and second illumination device 20₂ are superimposed (not shown), FIG. 2b shows illumination fields 35a and 35b separate from each other in scan direction 63. Since wafer 23 is arranged on support means 28, moveable in the x and y coordinate directions, illumination fields 35a and 35b move over dies 64 arranged on surface 22 of wafer 23.

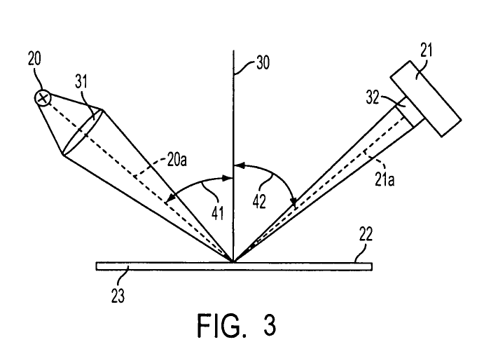

FIG. 3 again illustrates the variable arrangement of illumination device 20 and detector 21. In the arrangement shown in FIG. 3, illumination beam path 20a is inclined with respect to detection beam path 21a by an angle 41 or an angle 42 with respect to normal 30 on the surface of wafer 23. If angle 41 is equal to angle 42, this is referred to as a bright-field arrangement. If angle 41 is not equal to angle 42, this is referred to as a dark-field arrangement. This has the particular advantage that the user can switch between the two arrangements according to his measuring problem. In one case, the bright-field arrangement may be better suited for solving a measuring problem than the dark-field arrangement, and vice versa.

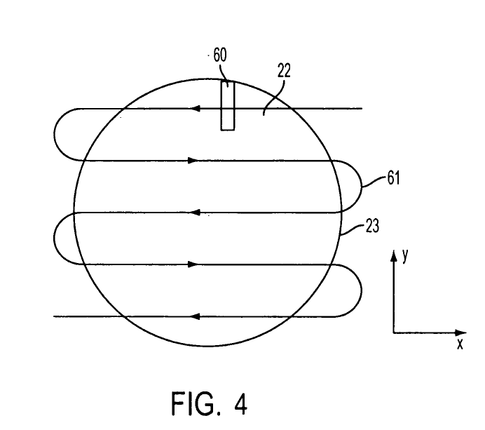

FIG. 4 shows how the detection or scanning of the entire surface 22 of a wafer 23 is carried out. The at least one illumination device 20 creates an illumination spot 60 on surface 22 of wafer 23, corresponding to one of illumination fields 35a or 35b of FIG. 2b, when only one illumination device is provided. Illumination spot 60 can also result from overlapping two or more illumination fields from a plurality of illumination devices. Illumination spot 60 can be configured as a line, a small area, an area of any particular shape, or as a symmetric area. If the illumination spot 60 is a line, the length of illumination spot 60 is greater than its width. Illumination spot 60 is guided along a meandering line 61, by moving wafer 23 in the x direction (scanning direction 63, see arrow) and the y direction, in order to scan the entire surface 22 of wafer 23.

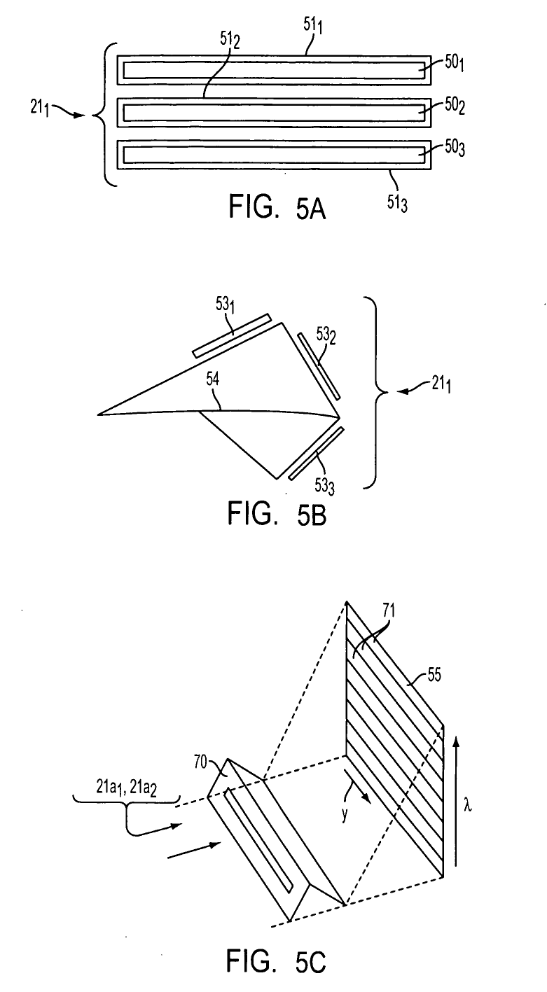

FIG. 5a is a detail view of the arrangement of FIG. 2a, wherein the detector includes a trilinear detector. Detectors 21₁ or 21₂ includes three detector lines 50₁, 50₂ and 50₃, each of which is provided with a corresponding color filter 51₁, 51₂ and 51₃. Using the trilinear detector, it is therefore possible for each of the detector lines 50₁, 50₂ and 50₃ to detect the light information from surface 22 of wafer 23 in a different color, depending on the embodiment of color filters or wavelength filters 51₁, 51₂ and 51₃.

FIG. 5b shows another embodiment of detector 21₁ and/or 21₂, wherein the detector includes a plurality of detector chips 53₁, 53₂ and 53₃. Detector chips 53₁, 53₂ and 53₃ are arranged around a dispersive arrangement 54, for spectrally splitting the impinging light, so that the individual detector chips 53₁, 53₂ and 53₃ each receive different color information. In a particular embodiment, first detector chip 53₁ can detect red light, second detector chip 53₂ can detect green light and third detector chip 53₃ can detect blue light.

FIG. 5c shows an embodiment of detector 21₁ and/or 21₂, wherein the detector includes a two-dimensional detector chip 55. In the present case, a dispersive element 70 is arranged in second detection beam path 21a₁ or 21a₂. Dispersive element 70 is for spatially separating the spectral portions of the detected light in detection beam path 21a₁ or 21a₂, so that the detected light can be imaged onto the individual detector lines 71 of detector chip 55 in a spectrally split manner. A lens (not shown) can be arranged downstream of dispersive element 70, which images the spatially split light in a suitable way onto the individual detector lines 71 of two-dimensional detector chip 55. The exemplary embodiment shown here is an imaging spectrometer.

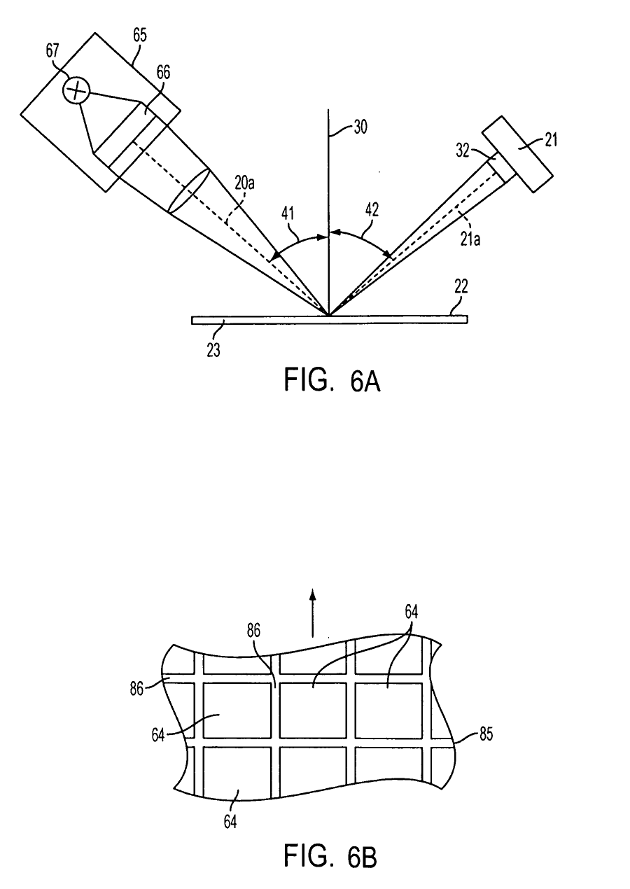

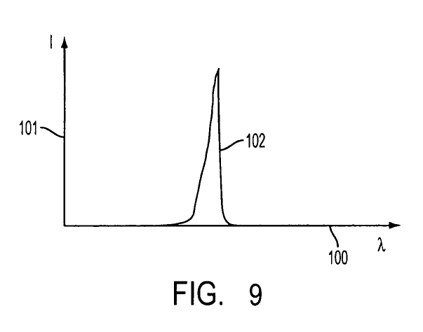

FIG. 6a is a schematic representation of another embodiment of illumination device 65 in illumination beam path 20₁. Illumination device 65 includes a digital modulator 66 (DMD) in illumination beam path 20₁ of light source 67. Illumination device 65 is arranged in an illumination beam path 20a. In the arrangement shown in FIG. 9a, illumination beam path 20a is inclined with respect to detection beam path 21a, by an angle 41 or an angle 42, respectively, with respect to normal 30 on surface 22 of wafer 23. If angle 41 is equal to angle 42, this is referred to as a bright-field arrangement. If angle 41 is not equal to angle 42, this is referred to as a dark-field arrangement. The present embodiment has the particular advantage that the user can switch between the two arrangements according to the measuring problem. In one case, the bright-field arrangement may be better suited for solving a measuring problem than the dark-field arrangement, and vice versa.

FIG. 6b is a schematic representation of a possible illumination pattern 85, which can be created with the aid of DMD 66 on surface 22 of wafer 23. In FIG. 6b an illumination pattern 85 is shown which takes dies 64 arranged on surface 22 of wafer 23 into account. Illumination pattern 85 can also be configured in such a way, for example, that areas 86, the so-called “streets” between dies 64, are illuminated with a different intensity to the dies 64 themselves. It is also conceivable, that the areas of illumination pattern 85 may differ from each other with respect to their wavelengths and/or their intensities.

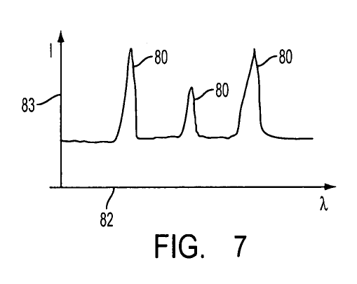

FIG. 7 shows the spectral composition of the illumination light when illumination device 20 is configured as a spectral line light source. In FIG. 5, abscissa 82 is the wavelength λ, and ordinate 83 is the intensity I. It can be quite easily seen that the spectral line light source shows different peaks 80, differing from each other in wavelength λ. It is obvious from the peaks formed with the spectral line light source that surface 22 of wafer 23 is spectrally illuminated.

In FIG. 8, again, abscissa 9 is wavelength λ, and ordinate 91 is the intensity. The continuously adjustable light source shows an intensity characteristic 92, essentially independent of wavelength λ. The continuously adjustable light source is controlled in such a way that a wavelength range or wavelength peak 93 selected by the user is emitted. Surface 22 of wafer 23 can then be illuminated with this wavelength peak 93 or this spectral interval.

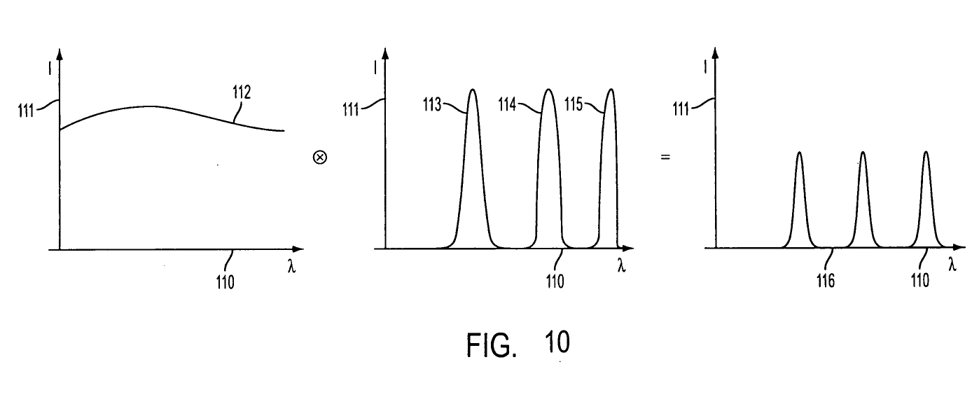

FIG. 9 shows the intensity of the illumination, when illumination device 20 is configured as an LED. Again, abscissa 100 is the wavelength % and ordinate 101 is the intensity. When only one type of LED is used an excellent peak 102 can be seen at wavelength λ. The surface of the wafer is then illuminated by this intensity peak. It goes without saying that LEDs may also be used which emit light at different wavelengths. It is obvious, that in the diagram of FIG. 10 a plurality of intensity peaks would then be discernible at different wavelengths.

FIG. 10 shows a broadband light source used with a filter, preferably a comb filter. First the broadband light source emits light which is essentially independent of wavelength λ. This is shown in FIG. 11a. In the figure, abscissa 110 is the wavelength λ, and ordinate 111 is the intensity I. The comb filter has the effect that light is transmitted only in a narrow wavelength range. As shown in FIG. 11b, in which, abscissa 110 is the wavelength λ, and ordinate 111 is the intensity I, the comb filter produces strong wavelength peaks at different wavelengths. The result of the broadband light source in combination with the comb filter is shown in FIG. 11c. Again, abscissa 110 is the wavelength λ, and ordinate 111 is the intensity I. When a three-band comb filter is used, the final result from the broadband light source, is a light characterized by three corresponding different wavelength peaks at different wavelengths.

While the present invention was described with respect to a particular embodiment, it is obvious to the person skilled in the art that modifications and changes to the invention can be made without departing from the scope of the appended claims.

1. An apparatus for inspecting a wafer, comprising:
a first illuminator for radiating an illumination beam in a first illumination beam path onto a surface of the wafer and being configured as continuous light source;
a second illuminator for radiating an illumination light beam in a second illumination beam path onto a surface of the wafer and being configured as continuous light source;
a first detector defining a first detection beam path;
a second detector defining a second detection beam path, wherein the first and the second detector means have a predetermined spectral sensitivity and detect data of at least an illuminated area moveable in a scanning direction on the surface of the wafer in a plurality of different spectral ranges.

2. The apparatus according to claim 1, wherein a polarizer is provided in at least one illumination beam path of the first and/or the second illuminator.

3. The apparatus according to claim 1, further comprising a digital modulator arranged downstream from at least one of the first and second illuminators allowing an illumination field to be created on the surface of the wafer, for creating areas on the surface of the wafer locally differing from each other with respect to wavelengths and/or intensities.

4. The apparatus according to claim 1, wherein light from the first illuminator and the second illuminator coincides in a common illuminated area on the surface of the wafer.

5. The apparatus according to claim 1, wherein light from the first illuminator and the second illuminator forms spatially separated areas in the scanning direction on the surface of the wafer.

6. The apparatus according to claim 1, wherein the second illuminator and the second detector are arranged in such a way that each of the second illumination beam path and the second detection beam path are inclined at an angle to a normal on the surface of the wafer.

7. The apparatus according to claim 6, wherein the angle at which the second detection beam path is inclined, is variable.

8. The apparatus according to claim 1, wherein the first or the second detection unit detects monochromatically or polychromatically.

9. The apparatus according to claim 1, wherein the first and/or the second illuminators includes a light source emitting light having a plurality of discreetly formed intensity peaks at different wavelengths.

10. The apparatus according to claim 1, wherein the first and/or the second illuminators is a continuously adjustable light source so that each required wavelength range can be adjusted.

11. The apparatus according to claim 1, wherein the first and/or the second illuminators includes at least one LED.

12. The apparatus according to claim 1, wherein the first and/or the second illuminators includes a broadband light source, wherein the individual wavelengths or wavelength ranges can be adjusted by corresponding filters.

13. The apparatus according to claim 1, wherein the first and/or the second detectors is a line camera.

14. The apparatus according to claim 1, wherein the first and/or the second detectors includes a trilinear detector, wherein the individual lines of the trilinear detector are provided with a suitable wavelength filter.

15. The apparatus according to claim 1, wherein the first and/or the second detectors includes three light-sensitive detector chips arranged around a dispersive arrangement in such a way that each of the detector chips receives a different wavelength.

16. The apparatus according to claim 1, wherein the first and/or the second detectors includes a two-dimensional light-sensitive detector chip having a dispersive element arranged upstream of it, for directing the different wavelength ranges onto different detector lines of the light-sensitive detector chip.
